(19) United States
(12) Patent Application Publication
(10) Pub. No.: US 2005/0263962 A1
(43) Pub. Date: Dec. 1, 2005

(54) Device for throwing an object

(76) Inventors: Warren Edward Roh, Littleton, CO (US); Dale Brian Halling, Colorado Springs, CO (US); Eckehart Zimmermann, Monument, CO (US); Michael Robert Collier, Denver, CO (US)

Correspondence Address: LAW OFFICE OF DALE B. HALLING, LLC, 655 SOUTHPOINTE COURT, SUITE 100, COLORADO SPRINGS, CO, 80906, US

(21) Appl. No.: 10/853,838

(22) Filed: May 26, 2004

(51) Int. Cl. F41J 9/00; A63B 65/00; F41J 1/00; F41J 5/00

(52) U.S. Cl. 273/317; 473/509

(57) ABSTRACT

A device for throwing an object has a first end of the device that functions as a handle. A second end of the device has at least two flexible appendages to hold an object. A tension adjustment device is coupled to the two flexible appendages.

### RELATED APPLICATIONS

None

### FIELD OF THE INVENTION

The present invention relates generally to the field of toys and more particularly to a device for throwing an object.

### BACKGROUND OF THE INVENTION

Children like to throw balls and launch balls out of energy enhancing devices. Pets, such as dogs, like to chase balls and other objects. Many people do not like to pick-up the ball after the dog's saliva is all over the ball. In addition, some people no longer are comfortable bending over for the ball multiple times and may not have the strength to throw the ball or cannot throw the ball over hand. One solution is a throwing stick that has a hemisphere made of flexible material that is used to pick up the ball. When a user flings the throwing stick the ball is launched from the fixed size hemisphere at the end of the throwing stick. Unfortunately, it has been found that some users are not able to fling the throwing stick with enough energy to release the ball from the fixed size hemisphere. In addition, some users throw the ball straight up or into the ground. Apparently, it is difficult for some users to master the motion to throw the ball in the intended direction. One solution these users have come up with is to partially dislodge the ball from the hemisphere before attempting to throw the ball with the throwing stick. While this makes it easier to throw the ball, it means the user now has to touch the ball with dog's saliva. In addition, this method makes it even harder to throw accurately, because the amount of tension holding the ball varies based on small changes in how far out the ball is pulled.

Thus there exists a need for a device for throwing an object that is easy to throw and does not require the user to put their hands on the ball.

### SUMMARY OF INVENTION

A device for throwing an object has a first end of the device that functions as a handle. A second end of the device has at least two flexible appendages to hold an object. A tension adjustment device is coupled to the two flexible appendages. The at least two flexible appendages may be a number of arms extending from the handle. The arms may flare towards the second end. The flexible arms may have a nodule. The tension adjustment device may be a collar that fits around the arms. The tension adjustment device may be coupled to a trigger. The handle may have a hollow portion.

In one embodiment, a device for throwing an object has a handle. A number of arms that each has a first end secured to the handle and each has a second end formed to hold an object. A slide fits over the arms. The object may be a ball with a pet treat inside. The first end of the arms may be affixed together. The arms may have a first position where the arms are partially encased in the handle. One of the arms may be stiffer than the other arms. The handle may be hollow. The handle may have a chuck feature for holding the first end of the arms.

In one embodiment, a device for throwing an object has a handle with a first end and a second end. At least a pair of appendages capable of holding objects of different sizes attached to the second end of the handle. The handle may be hollow. An opening in the hollow handle may engage an accessory. A hinge may be located between the pair of appendages. A biasing device may be coupled to the hinge. The pair of appendages may be made of a flexible material.

### BRIEF DESCRIPTION OF THE DRAWINGS

FIG. 1 is a side view of a device for throwing an object in accordance with one embodiment of the invention;

FIG. 2 is a side view of a device for throwing an object holding a ball in accordance with one embodiment of the invention;

FIG. 3 is a side view of a device for throwing an object in accordance with one embodiment of the invention;

FIG. 4 is a cross section of a device for throwing an object in accordance with one embodiment of the invention;

FIG. 5 is a cross section of a device for throwing an object in accordance with one embodiment of the invention;

FIG. 6 is a side view of a device for throwing an object in accordance with one embodiment of the invention;

FIG. 7 is a partial cross section of a device for throwing an object in accordance with one embodiment of the invention;

FIG. 8s is a device for throwing an object in accordance with one embodiment of the invention;

FIG. 8b is a cross section of a device for throwing an object in accordance with one embodiment of the invention;

FIG. 8c is a cross section of a device for throwing an object in accordance with one embodiment of the invention;

FIG. 9 is a top left perspective view of a handle for a device for throwing an object in accordance with one embodiment of the invention;

FIG. 10 is a top left perspective view of a handle for a device for throwing an object in accordance with one embodiment of the invention;

FIG. 11 is a top left perspective view of a chuck device for a device for throwing an object in accordance with one embodiment of the invention;

FIG. 12 is a top left perspective view of handle for a device for throwing an object in accordance with one embodiment of the invention;

FIG. 13 is a top left view of an accessory for a device for throwing an object in accordance with one embodiment of the invention;

FIGS. 14a & b are a front view of a device for throwing an object in accordance with one embodiment of the invention;

FIG. 15a is a front view of a device for throwing and object in accordance with one embodiment of the invention;

FIG. 15b is a side view of a device for throwing and object in accordance with one embodiment of the invention;

FIG. 15c is a back cross sectional view of a device for throwing and object in accordance with one embodiment of the invention;

FIG. 16a is a cross section side view of a device for throwing and object in accordance with one embodiment of the invention;

FIG. 16b is a cross section back view of a device for throwing and object in accordance with one embodiment of the invention;

FIG. 16c is a cross section side view of a device for throwing and object in accordance with one embodiment of the invention;

FIG. 16d is a cross section front view of a device for throwing and object in accordance with one embodiment of the invention;

FIG. 17a is a front view of a device for throwing an object in accordance with one embodiment of the invention;

FIG. 17b is a side view of a device for throwing an object in accordance with one embodiment of the invention; and

FIG. 17c is a side view of a device for throwing an object in accordance with one embodiment of the invention.

### DETAILED DESCRIPTION OF THE DRAWINGS

A device for throwing an object has a variable tension adjustment which allows people to adjust the device for their throwing strength. In one embodiment, the variable tension adjustment is a collar that adjusts the tension between a number of arms. As a result, the tension can be adjusted without the user touching a ball with dog saliva. In addition, the present invention allows the user to throw the object more accurately and throw the object underhand if it is difficult for the user to raise their hand above their head.

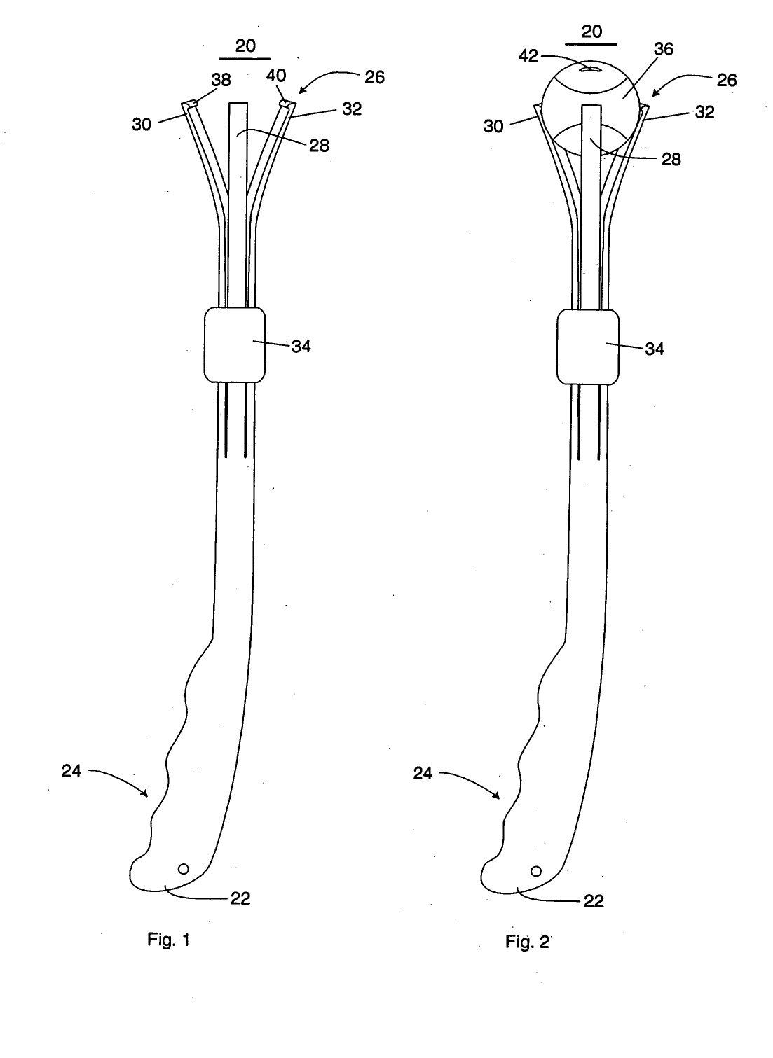

FIG. 1 is a side view of a device 20 for throwing an object in accordance with one embodiment of the invention. The device 20 has a first end 22 that functions as a handle 24. The second end 26 of the device 20 has at least two flexible appendages. In this embodiment of the invention, the appendages are three arms 28, 30, 32. The three arms 28, 30, 32 flare out from each other toward the second end 26. A tension adjustment device 34 is a slide that pulls the arms 28, 30, 32 closer to each other. The slide 34 fits around the three arms 28, 30, 32 of the device 20. As the slide 34 is moved toward the second end 26 of the device 20 it increases the tension on the object 36 (See FIG. 2). This feature also allows the device 20 to pick up and throw objects of different size, for instance, tennis balls, racket balls and other balls of differing sizes. The arms 28, 30, 32 each have nodule 38 & 40 (the other nodule cannot be seen in this view). The nodules 38, 40 help to trap the object 36. The object 36 may be captured by pressing the second end 26 down on the object 36. The arms 28, 30, 32 are flexible and will spread apart to allow the object 36 to be captured by the nodules 38, 40. This process may be facilitated by easing the tension by moving the slide 34 toward the handle 24. In one embodiment, the arms 28, 30, 32 are made of a flexible plastic. Flexible as used herein means in the context of human strength pushing the arms over a tennis ball or similar ball. In another embodiment, the ball 36 has an opening 42 so that a treat may be placed inside the ball 36. The ball 36 is squeezed to separate the two sides of the opening 42 and the treat is places inside. Once the ball 36 is released the two sides will abut each other holding the treat with the ball 36.

The embodiment of the device 20 shown in FIGS. 1 & 2 shows one specific implementation of the device 20. The invention encompasses a number of different embodiments. For instance, the three arms could be replaced by two clam shells and a spring with an adjustable spacing as the adjustable tensioning device. The slide 34 could be implemented as a snap on bracket or it could be a wedge in the center of the arms that pushed the arms apart as it was moved towards the first end. Many other embodiments will be apparent to those skilled in the art.

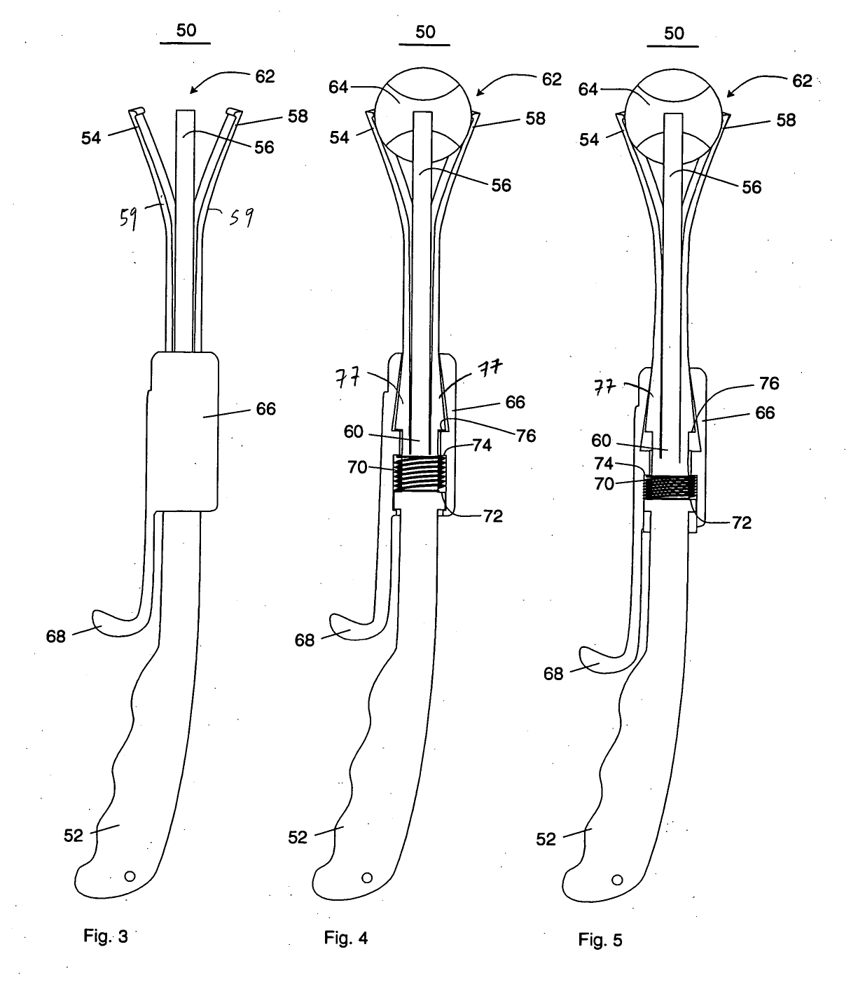

FIG. 3 is a side view of a device 50 for throwing an object in accordance with one embodiment of the invention. Cross sections of this embodiment of the device 50 are shown in FIGS. 4 & 5. The device 50 has a handle 52. A plurality of arms 54, 56, 58 have first end 60 (best seen in FIG. 5) secured to the handle 52. A second end 62 of the arms are formed to hold an object 64. Note that the arm 54, 56, 58 may have a bend 59 to increase the flaring near the second end 62. A slide 66 coupled to a trigger 68 fits over the arms 54, 56, 58. A spring 70 fits between a stop 72 in the handle 52 and a stop 74 on the slide 66 and trigger 68 assembly. The arms 54, 56, 58 have a stop 76 that keeps the slide 66 from moving all the way up the arms 54, 56, 58. In FIG. 4 the trigger is released and the slide 66 is moved toward the second end 62 of the arms. This decreases the tension on the object 64 because of the wedges 77 in the arms 54, 54, 58. In FIG. 5 the trigger is pulled towards the handle 52 and this increases the tension on the arms 54, 56, 58. As a result, by releasing the trigger 68 it makes it easier for the user to pick up a ball. Releasing the trigger while flinging the device will release the ball. This allows the user to more accurately throw the object 64.

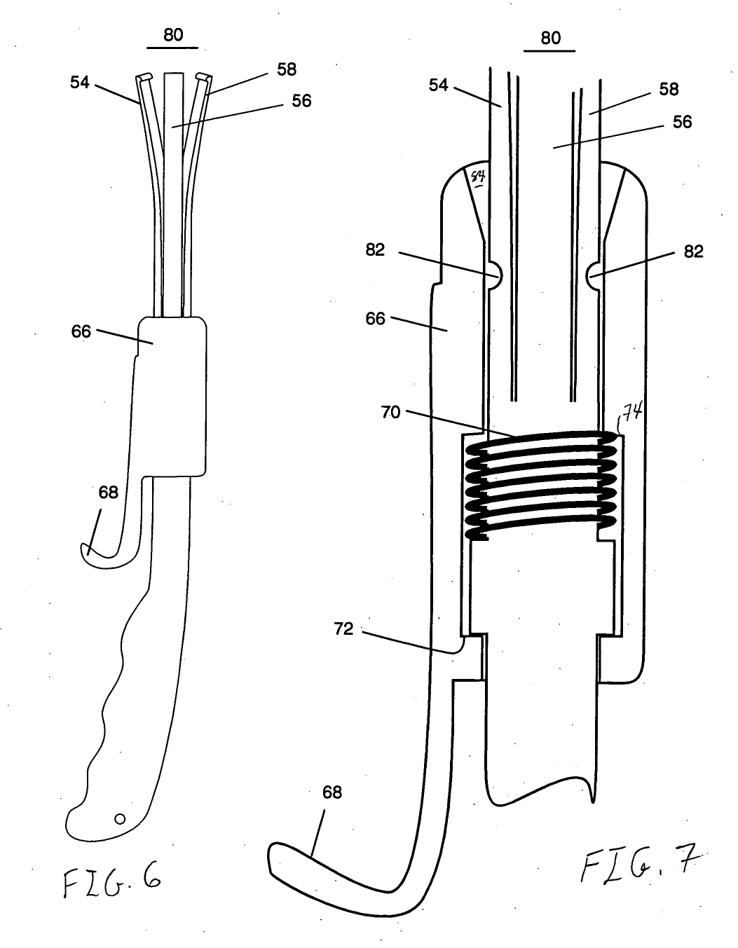

FIG. 6 is a side view of a device 80 for throwing an object in accordance with one embodiment of the invention. This embodiment is similar to the embodiment shown in FIGS. 3-5 and the same reference numeral will be used for similar parts. The differences in this embodiment are shown in FIG. 7. In this embodiment, there are living hinges 82 in the arms 54, 56, 58. The sleeve 66 has a partial conical cutout 84. As a result, when the trigger 68 is pulled toward the handle (against the spring) the hinges 84 are released which releases the object.

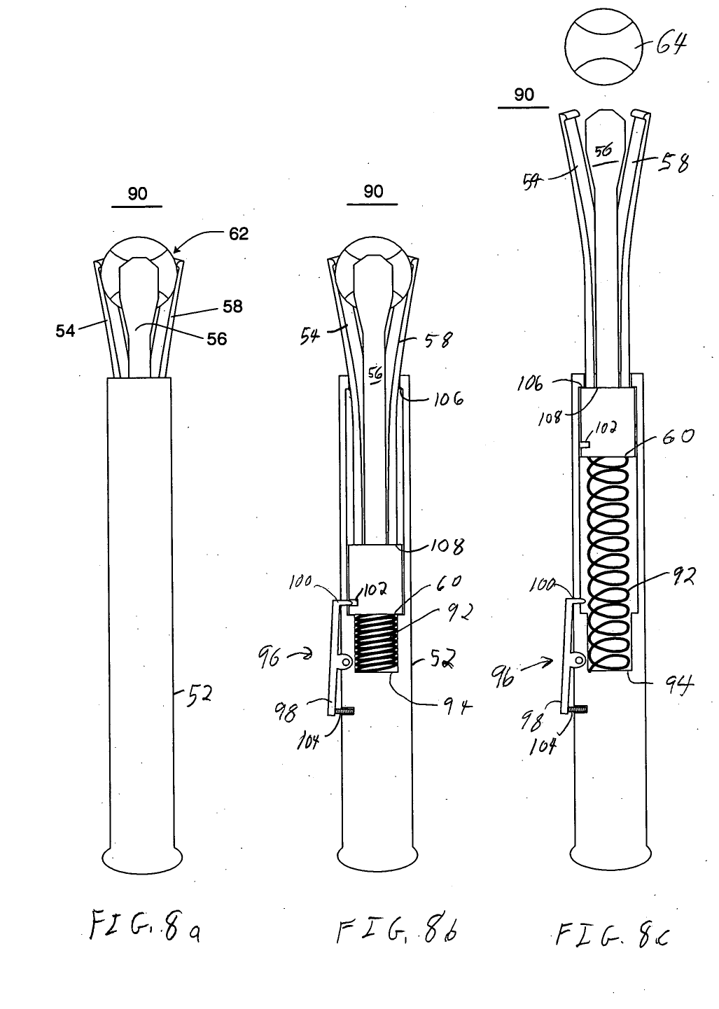

FIGS. 8a-c show another embodiment of a device 90 for throwing an object in accordance with one embodiment of the invention. As shown in FIG. 8b the handle 52 is hollow and the arms 54, 56, 58 are partially inserted into the handle 52. In another embodiment, the arms can be completely encased by the handle. A spring 92 fits between a first end 60 of the arms 54, 56, 58 and a brace 94 in the handle 52. A trigger 96 has a lever 98 with a stop 100 at one end. The stop 100 engages a dimple 102 in the arms 54, 56, 58. A spring 104 biases the stop against the dimple 102. When the trigger 96 is depressed the spring 92 forces the arms out of the handle 52. The arms 54, 56, 58 are prevented from completely being removed from the handle by a flange 106 in the handle 52 engaging a cylinder 108 at the first end of the arms 54, 56, 58. Inserting the arms 54, 56, 58 into the handle 52 increases the tension on an object. In one embodiment, the user starts to fling the handle 52 and presses down on the trigger. This causes the arms 54, 56, 58 to spring out of the handle 52 and reduces the tension on an object in the second end 62 of the arms 54, 56, 58. Thus the object is released. Note that in this embodiment, one of the arms 56 is different from the other arms. In one embodiment, arm 56 may be stiffer than the other arms. To throw the ball the user would align the stiffer arm 56 so it was closest to them when throwing the ball. It is believed this feature increases the accuracy and throwing distance when the toy is used.

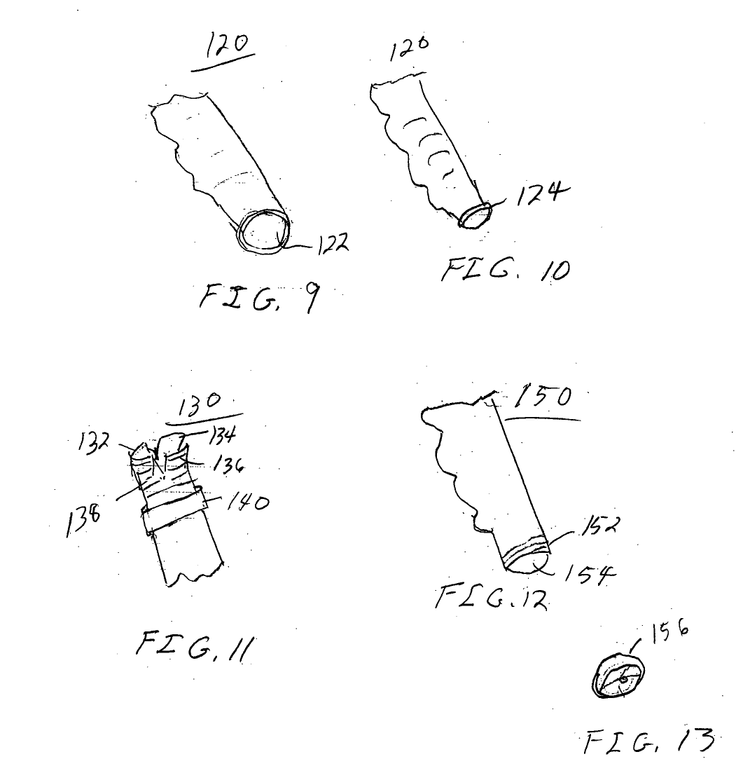

FIG. 9 is a top left perspective view of a handle 120 for a device for throwing an object in accordance with one embodiment of the invention. This embodiment shows that the handle 120 is hollow and has an opening 122. This cavity may be used to store items such as pet treats, bags to pick-up pet waste, flashlights etc. FIG. 10 shows a cover 124 over the opening to hold the objects in the cavity. The cover 124 may be a cap that fits over the opening.

FIG. 11 is a top left perspective view of a chuck device 130 for a device for throwing an object in accordance with one embodiment of the invention. The chuck device 130 may be used at one end of the handle 52 to hold the arms 54, 56, 58 on the handle 52. However, the chuck device 130 may be used to attach the handle to other objects. The chuck device 130 has a number of flanges 132, 134, 136 that flare slightly. The flanges 132,134, 136 are threaded 138. The threading 138 may extend below the flanges. A female ring 140 screws onto the flanges 132, 134, 136 and closes the flanges 132, 134, 136 on the arms of the throwing device.

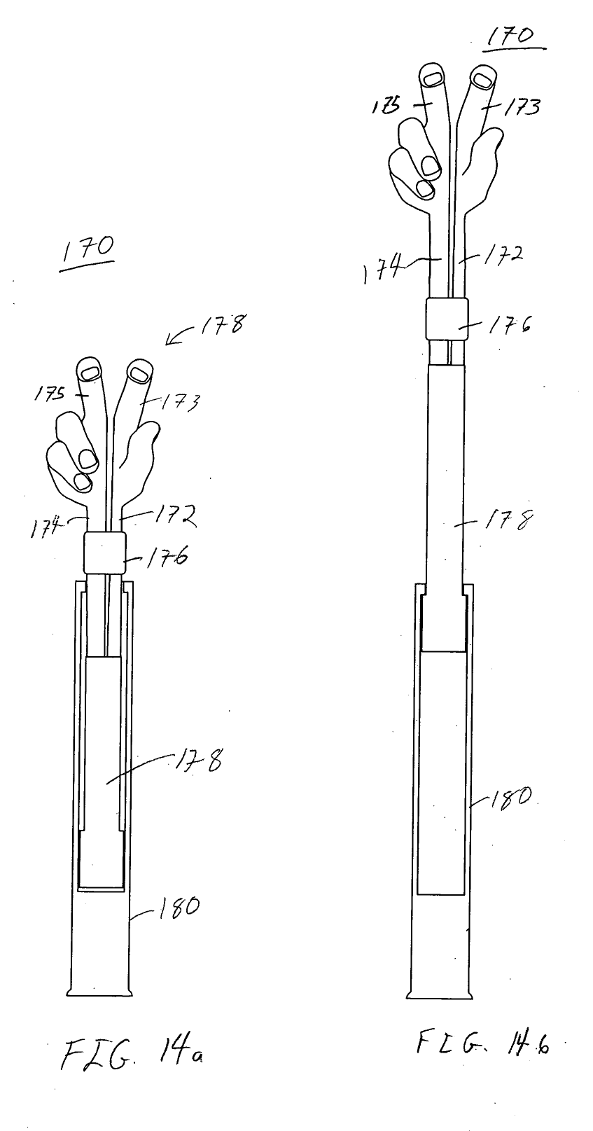

FIG. 12 is a top left perspective view of handle 150 for a device for throwing an object in accordance with one embodiment of the invention. The end 152 of the handle 150 is threaded and the handle 150 has an opening 154. This allows a number of accessories to be placed in the handle 150. For instance, batteries may be inserted into the handle with the appropriate wiring and a flashlight 156 (see FIG. 13) may screwed onto the end of the handle 150. Other accessories may also be used with this handle such as specialized dog leashes and mace or pepper spray.

FIGS. 14a & b are a front view of a device 170 for throwing an object in accordance with one embodiment of the invention. In this embodiment, the device has two arms 172, 174 having first ends 178 that are shaped like a hand throwing an object. The hand parts 173, 175 are designed to hold an object and are made of flexible material. A tension adjusting device 176 fits over the two arms. The arms 172, 174 attach to an extender 178. The extender 178 slides within a handle 180. The extender 178 may include a locking system that semi-permanently holds the extender 178 at a certain length. Such locking systems are well known in the art. The ability to extend the length of the throwing device 170 allows the user to throw the object farther when the length is extended.

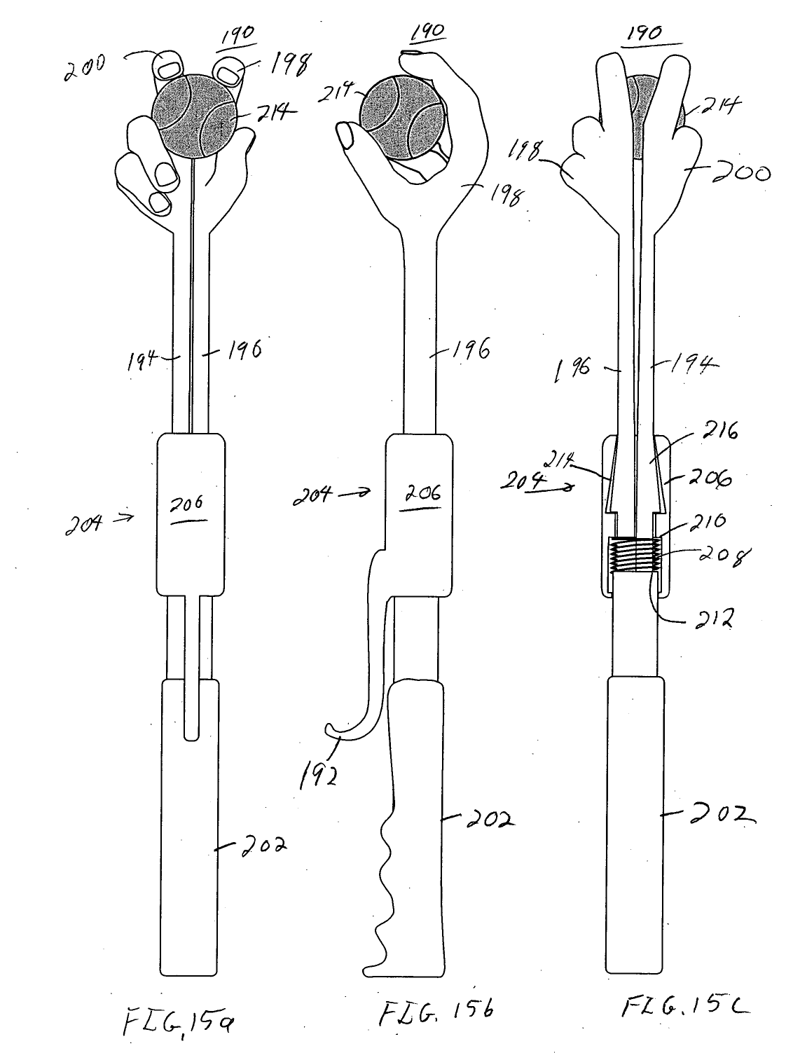

FIGS. 15a-c show a device 190 for throwing and object in accordance with one embodiment of the invention. This device is similar to the device of FIGS. 14a & b, except that it has a trigger release 192 and is not extensible. The device 190 has two arms 194, 196. One end of the arms are shaped liked hand parts 198, 200. The arms 194, 196 are coupled to a handle 202. A trigger mechanism 204 has a sleeve 206 coupled to a trigger 192. The sleeve 206 engages a spring 208. The spring 208 is captured between a lip 210 of the sleeve 206 and a lip 212 of the handle 202. The spring 208 is compressed when the trigger 192 is pulled. The sleeve has a conical wedge shape 214 that engages a mating conical wedge shape 216 of the arms 196 & 198. As a result, when the trigger 192 is pulled the tension between the arms 194 & 196 is increased, which increases the tension on the ball 214.

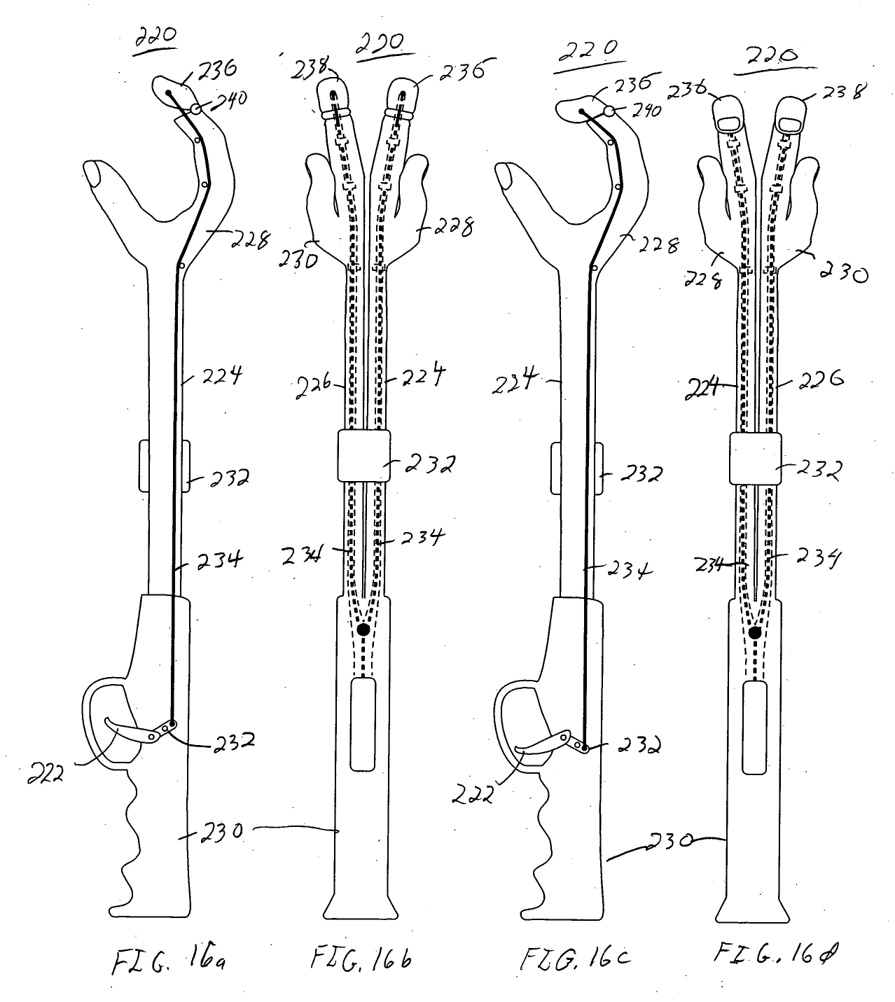

FIGS. 16a-d show a device 220 for throwing an object in accordance with one embodiment of the invention. Note that FIGS. 16 & b show the device 220 with trigger 222 released and FIGS. 16c & d show the device 220 with the trigger 222 pulled. The device 220 has two arms 224 & 226 that have two hand parts 228 & 230 at one end. A tension adjusting device 232 fits over the two arms 224, & 226. The arms 224 & 226 are connected to a handle 230. The handle has a trigger 222 coupled to linkage mechanism 232. The linkage mechanism 232 is coupled to a pair of linking cords 234 that attach to the ends of finger parts 236 & 238. The finger parts 236 & 238 have hinge springs 240 that bias the fingers open. When the trigger 222 is pulled the fingers are closed.

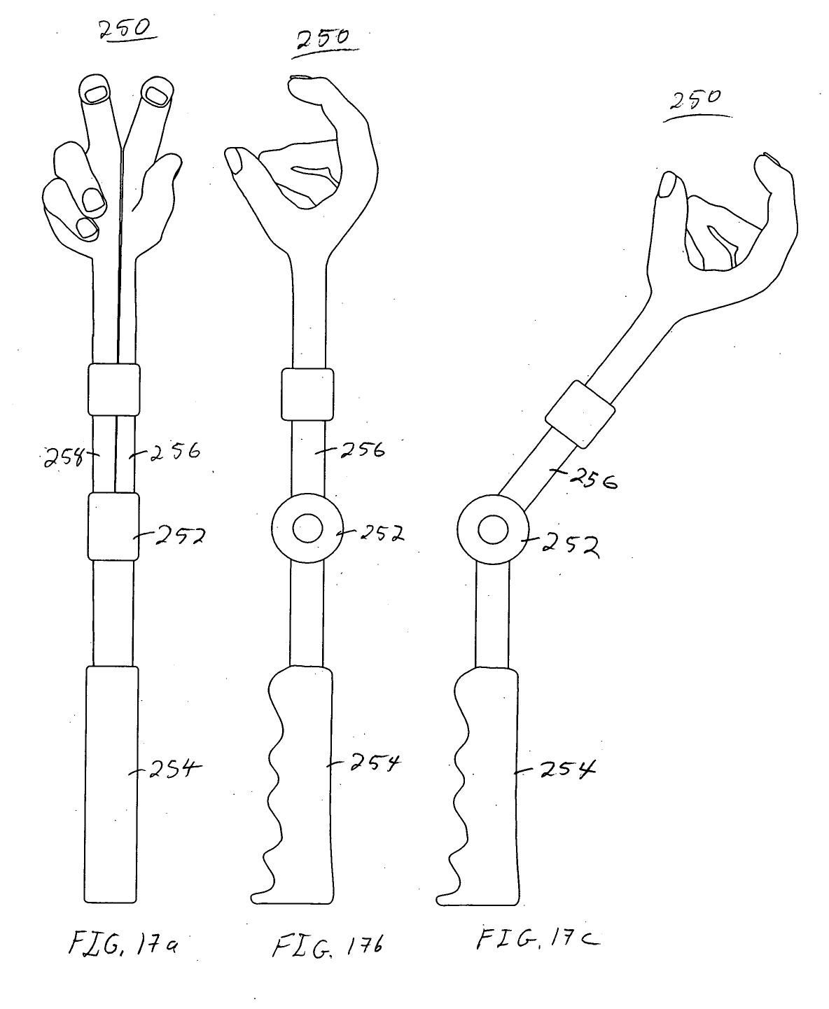

FIGS. 17a-c show a device 250 for throwing an object. This embodiment of the device 250 is very similar the device in FIGS. 14a & b except that the length is not extensible and a spring biased hinge 252 connects the handle 254 to the arms 256 & 258. The hinge spring 252 biases the arms 256 & 258 to be inline with the handle 254. When the user swings the device 250, the arms 256 & 258 rotate back as shown in FIG. 17c. As the user finishes their swing the arms 256 & 258 spring back into the position shown in FIG. 17b. The spring hinge 252 may be made in a variety of ways that are well known to those skilled in the art. The invention encompasses all of these possible variations.

Thus there has been described a device for throwing an object that is easy to throw and does not require the user to put their hands on the ball.

While the invention has been described in conjunction with specific embodiments thereof, it is evident that many alterations, modifications, and variations will be apparent to those skilled in the art in light of the foregoing description. For instance, the number of arms used with the device could be 2 or more. The collar may be a slide or may be a female threaded ring. The object could be a ball of multiple sizes, a chew toy, a throwing disk, etc. Accordingly, it is intended to embrace all such alterations, modifications, and variations in the appended claims.

1. A device for throwing an object, comprising:
a first end of the device functioning as a handle;
a second end of the device having at least two flexible appendages to hold an object; and
a tension adjustment device coupled to the two flexible appendages.

2. The device of claim 1, wherein the at least two flexible appendages are a plurality of arms extending from the handle.

3. The device of claim 2, wherein the plurality of arms flare towards the second end.

4. The device of claim 3, wherein the tension adjustment device has two positions.

5. The device of claim 2, wherein the tension adjustment device is a collar that fits around the plurality of arms.

6. The device of claim 5, wherein the tension adjustment device is coupled to a trigger.

7. The device of claim 1, wherein the handle has a hollow portion.

8. A device for throwing an object, comprising:
a handle;
a pair of flexible arms each having a first end secured to the handle and each having a second end formed to hold an object; and
a tension adjusting device coupling the plurality of arms.

9. The device of claim 8, wherein the object has an opening.

10. The device of claim 8, wherein the first end of the plurality of arms are affixed together.

11. The device of claim 10, wherein the plurality of arms have a first position where the plurality of arms are partially encased in handle.

12. The device of claim 11, wherein one of the plurality of arms is stiffer than the other plurality of arms.

13. The device of claim 8, wherein the handle is hollow.

14. The device of claim 13, wherein the handle has a chuck feature for holding the first end of the plurality of arms.

15. A device for throwing an object, comprising:
a handle having a first end and a second end;
at least a pair of appendages capable of holding objects of different sizes attached to the second end.

16. The device of claim 15, wherein the handle is hollow.

17. The device of claim 16, wherein an opening of the hollow handle engages an accessory.

18. The device of claim 15, further including a hinge between the at least the pair of appendages.

19. The device of claim 15, further including a biasing device coupled to the hinge.

20. The device of claim 15, wherein the at least the pair of appendages are made of a flexible material.
